(19) United States
(12) Patent Application Publication
(10) Pub. No.: US 2003/0019439 A1
(43) Pub. Date: Jan. 30, 2003

(54) Cage top with compartment

(76) Inventors: Robert C. Krause, Elk Grove Village, IL (US); Yuzo Migita, Elk Grove Village, IL (US); Kazutoshi Tominaga, Elk Grove Village, IL (US)

Correspondence Address: Douglas B. White, 1000 East Woodfield Rd., #102, Schaumburg, IL, 60173, US

(21) Appl. No.: 09/915,138

(22) Filed: Jul. 25, 2001

(51) Int. Cl. A01K 1/02; A01K 1/03; A01K 31/06

(52) U.S. Cl. 119/472

(57) ABSTRACT

A top for a small animal cage provides an access compartment therein. Selective access to the animal by the pet owner is obtained through a hinged lid, and access to the compartment by the animal is provided through openings in the compartment which communicate to the cage interior.

### CROSS REFERENCE TO RELATED APPLICATIONS

An application for a design patent is co-pending herewith.

### STATEMENT REGARDING FEDERALLY SPONSORED RESEARCH OR DEVELOPMENT

Not Applicable

### BACKGROUND OF THE INVENTION

1. Field of the Invention

The present invention relates generally to lids or tops for cages for small pets, such as hamsters. More particularly, this invention relates to an improvement in such a cage top which provides a controlled compartment for access to the pet.

2. Description of the Prior Art

Prior art cages typically present a wire or plastic top covering the uppermost end of the cage, without any access to the cage interior. In some designs, tubes are connected to the cage top to allow movement of the pet therethrough, but access to the pet is still limited to the main cage door located on the cage side.

### SUMMARY OF THE INVENTION

Accordingly, it is the objective of this invention to provide a top for a small animal cage which facilitates access to the pet through the cage top and provides a convenient location for handling the pet.

The present invention comprises a top for a small animal cage which provides an access compartment therein. The top includes an accessible compartment with a hinged lid for selective access to the animal. Access to the compartment by the animal is provided through openings in the compartment which communicate to the cage interior.

### BRIEF DESCRIPTION OF TIRE DRAWINGS

FIG. 1 is a perspective view of a cage employing the cage top of the present invention, showing the access compartment in the open position.

FIG. 2 is a top view of the cage top of the present invention.

FIG. 3 is a side view of the cage top of FIG. 1 showing the access compartment with the lid in the closed position.

FIG. 4 is a side view of the cage top of FIG. 1 showing the access compartment with the lid in the open position.

While the invention will be described in connection with a preferred embodiment, it will be understood that it is not the intent to limit the invention to that embodiment. On the contrary, it is the intent to cover all alternatives, modifications, and equivalents as may be included within the spirit and scope of the invention as defined by the appended claims.

### DESCRIPTION OF THE PREFERRED EMBODIMENT

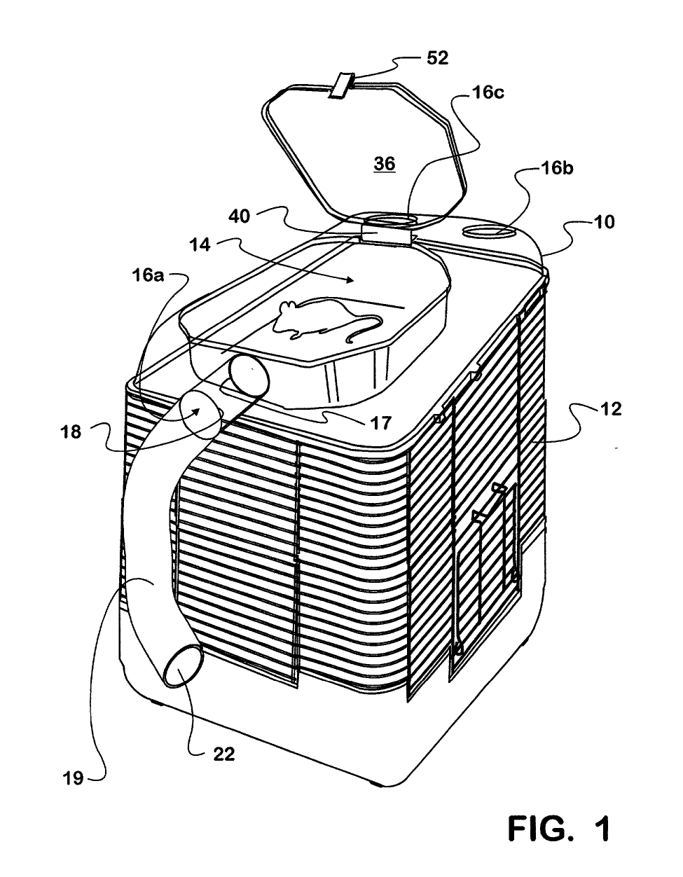

Turning first to FIG. 1 there is shown a top 10 for a cage for small animals in accordance with the present invention. This cage top includes a generally transparent plastic surface member which spans the top opening of the cage defined by the vertical sides 12 of the cage. This cage top includes an access compartment 14, more fully described below, and tube connection means 16a-c for connecting to access tube accessories, well known to the art.

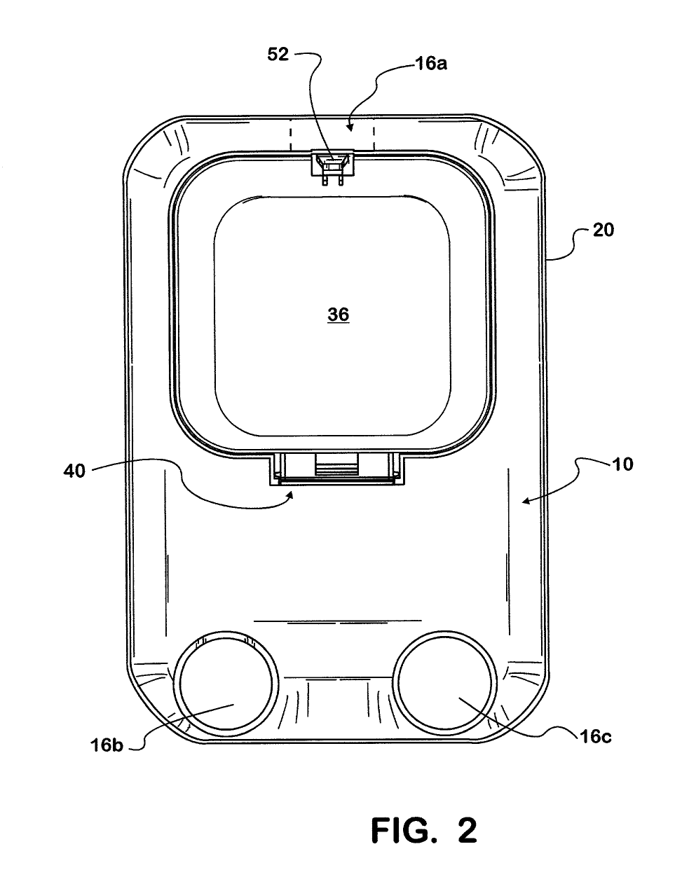

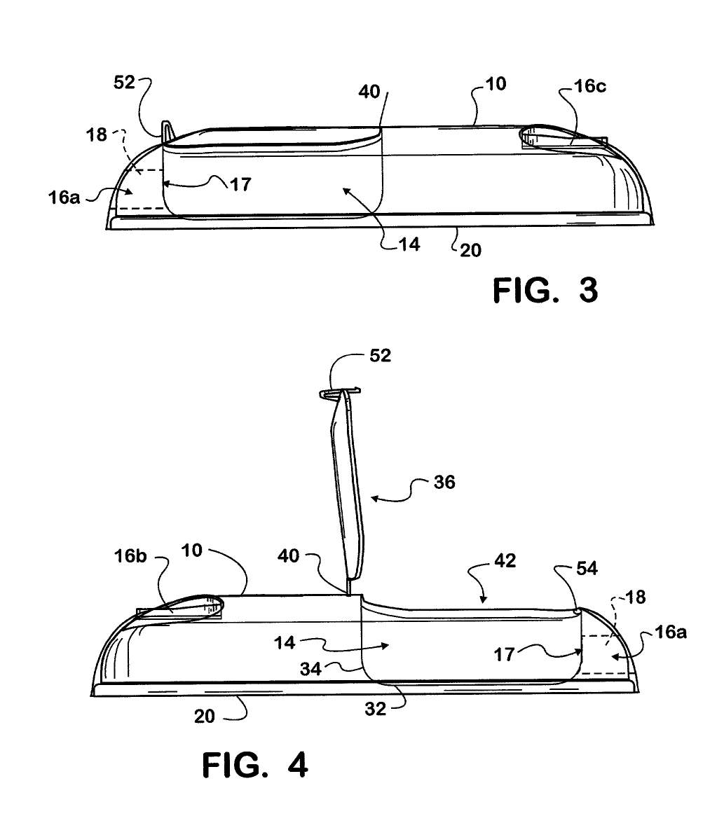

As shown more clearly in FIGS. 2-4, the cage top 10 includes a surface member having engaging edges 20 defined thereon for engagement with the vertical sides 12 of the cage. The access compartment 14 (see FIGS. 3-4) is incorporated into or otherwise affixed to the cage top for selective access to the animal. In the preferred embodiment, this access compartment is formed as an integral part of the cage top.

Access to the compartment 14 by the animal may be provided by any opening in the compartment leading to the cage interior, but in the preferred embodiment access is provided through tube connection means 16a for connection to animal access tubes. This tube connection means includes a tube connection opening 17 provided at the side of the compartment for connecting via an opening 18 in the cage top to a tube accessory 19. The tube accessory then connects the compartment 14 to other tube connection openings provided in the cage or in the cage top through its extremity 22. Particularly, this tube connection is connectable to other tube connection means openings 16b or 16c available in the cage top or tube connection means openings in the cage side, not shown.

The access compartment 14 includes a compartment bottom 32, compartment sides 34 and a hinged compartment lid 36. This lid 36 is attached to the cage top surface member by a hinge mechanism 40 and covers the compartment opening 42 (shown in FIG. 4), when it is closed as shown in FIG. 5. Secure closure of the lid is provided by a flexible tab 52 which extends into the compartment and catches on a latching edge 54 located therein.

From the foregoing description, it will be apparent that modifications can be made to the apparatus and method for using same without departing from the teachings of the present invention. Accordingly, the scope of the invention is only to be limited as necessitated by the accompanying claims.

What is claimed is:

1. A top for a small animal cage having vertical sides thereon, said top comprising:
a cage top spanning a top opening defined by the cage; and
an access compartment within said cage top for selective access to the animal, said access compartment being accessible to the animal from the cage.

2. The apparatus of claim 1 wherein said access compartment further comprises means for connection to animal access tubes.

3. The apparatus of claim 1 wherein said access compartment is affixed to said cage top.

4. The apparatus of claim 1 wherein said access compartment is incorporated into said cage top.

5. The apparatus of claim 1 wherein said access compartment is integral with said cage top.

6. The apparatus of claim 5 wherein said access compartment further comprises means for connection to animal access tubes.

7. The apparatus of claim 1 wherein said access compartment further comprises a hinged lid.

8. The apparatus of claim 7 wherein said access compartment further comprises means for connection to animal access tubes.

9. The apparatus of claim 8 wherein said surface member further comprises means for connection to animal access tubes.

10. The apparatus of claim 8 wherein said cage top further comprises a plurality of means for connection to animal access tubes.

11. An access compartment in a top for a small animal cage comprising:
a compartment defined within the cage and affixed to the cage top;
a lid defined in said cage top for access to the compartment by the pet owner; and
an opening in said compartment, said opening communicating to the cage interior for access to said compartment by the animal.

12. The apparatus of claim 11 wherein said access compartment further comprises a hinged lid.

13. The apparatus of claim 11 wherein said access compartment is incorporated into said cage top.

14. The apparatus of claim 13 wherein said access compartment is integral with said cage top.

15. The apparatus of claim 14 wherein said access compartment further comprises means for connection to animal access tubes.

16. The apparatus of claim 12 wherein said access compartment further comprises means for connection to animal access tubes.

17. The apparatus of claim 16 wherein said cage top further comprises means for connection to animal access tubes.

18. The apparatus of claim 17 wherein said cage top further comprises a plurality of means for connection to animal access tubes.

19. The apparatus of claim 11 wherein said cage top further comprises means for connection to animal access tubes.

20. The apparatus of claim 19 wherein said cage top further comprises a plurality of means for connection to animal access tubes.
